(19) United States
(12) Patent Application Publication
(10) Pub. No.: US 2026/0367292 A1
(43) Pub. Date: Nov. 19, 2026

(54) Tunable Lens with Indirect Actuators

(71) Applicant: Apple Inc., Cupertino, CA (US)

(72) Inventors: David Kuan Wei Ooi, Cambridge (GB); Daniel J Burbridge, Cambridge (GB); Oliver Hart, Cambridge (GB)

(21) Appl. No.: 19/647,561

(22) Filed: Apr. 14, 2026

Related U.S. Application Data
(60) Provisional application No. 63/805,791, filed on May 14, 2025.

(51) Int. Cl. G02B 3/14; G02B 27/01; G02F 1/29

(52) U.S. Cl. CPC G02B 3/14; G02F 1/294; G02B 27/0172

(57) ABSTRACT

An electronic device may include a lens module with a tunable lens. The tunable lens may include a flexible lens element and a lens shaping structure attached to the flexible lens element. The lens shaping structure may include tabs that are each coupled to a respective actuator. The actuator may move the tab up and down along an axis of displacement. The actuators may be indirect actuators that each includes a preloaded force component, such as one or more springs, an adjustment mechanism, such as a lever, and an actuating component, such as a motor and/or one or more shape memory alloy wires. The actuating component may adjust the adjustment mechanism to adjust the lens shaping element using a preloaded force from the preloaded force component, reducing the energy needed to adjust the lens shaping element.

This application claims the benefit of U.S. provisional patent application No. 63/805,791, filed May 14, 2025, which is hereby incorporated by reference herein in its entirety.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users'heads. The head-mounted devices may include optical systems with lenses.

Head-mounted devices typically include lenses with fixed shapes and properties. If care is not taken, it may be difficult to adjust these types of lenses to optimally present content to each user of the head-mounted device.

### SUMMARY

A tunable lens may include a lens shaping element and an indirect actuator coupled to the lens shaping element. The indirect actuator may include a preloaded force component, an adjustment mechanism coupled to the preloaded force component, and an actuating component coupled to the adjustment mechanism. The actuating component may be configured to adjust the adjustment mechanism to adjust the lens shaping element using a preloaded force from the preloaded force component.

An indirect actuator may be configured to adjust a lens shaping element of a tunable lens, and the indirect actuator may include a preloaded force component, an adjustment mechanism coupled to the preloaded force component, and an actuating component coupled to the adjustment mechanism. The actuating component may be configured to adjust the adjustment mechanism to adjust the lens shaping element using a preloaded force from the preloaded force component.

A tunable lens may include a lens shaping element, and an indirect actuator coupled to the lens shaping element. The indirect actuator may include at least one preloaded spring, an adjustment mechanism coupled to the at least one preloaded spring, and an actuating component coupled to the adjustment mechanism. The actuating component may be configured to adjust the adjustment mechanism to adjust the lens shaping element using a force from the at least one preloaded spring.

### BRIEF DESCRIPTION OF THE DRAWINGS

FIG. 1 is a schematic diagram of an illustrative electronic device in accordance with some embodiments.

FIG. 2 is a top view of an illustrative head-mounted device with a lens module in accordance with some embodiments.

FIG. 3 is a side view of an illustrative lens module in accordance with some embodiments.

FIGS. 4 and 5 are side views of an illustrative tunable lens in different tuning states in accordance with some embodiments.

FIG. 6 is a top view of an illustrative tunable lens with a lens shaping structure that is adjustable using actuators in accordance with some embodiments.

FIG. 7 is a side view of an illustrative indirect actuator for a tunable lens that includes a lever that rotates about a movable pivot in accordance with some embodiments.

FIG. 8 is a side view of an illustrative indirect actuator for a tunable lens that includes a cantilever beam in accordance with some embodiments.

FIG. 9 is a side view of an illustrative indirect actuator for a tunable lens that includes a tension spring, a compression spring, and an adjustable component between the two springs in accordance with some embodiments.

FIGS. 10A-10D are side views of an illustrative indirect actuator for a tunable lens that includes a spring and an adjustable component in accordance with some embodiments.

FIG. 11 is a side view of an illustrative indirect actuator for a tunable lens that includes a lever coupled to a spring and an actuated wire in accordance with some embodiments.

FIG. 12 is a side view of an illustrative indirect actuator that includes a rotating joint in accordance with some embodiments.

FIG. 13 is a side view of an illustrative indirect actuator that includes a pivot and sliding joint in accordance with some embodiments.

FIG. 14 is a side view of an illustrative indirect actuator that includes a pivoting flexure in accordance with some embodiments.

FIG. 15 is a side view of an illustrative indirect actuator that includes a piezoelectric brake in accordance with some embodiments.

FIG. 16 is a side view of an illustrative global actuator that is coupled to multiple local, indirect actuators in accordance with some embodiments.

### DETAILED DESCRIPTION

An electronic device, such as a head-mounted device, may include a tunable lens. The tunable lens may have adjustable optical properties. For example, actuators may move a periphery of the tunable lens to adjust the optical properties. In some embodiments, the actuators may include structures that are coupled to the tunable lens and that rotate about pivot axes.

To reduce the amount of energy required to more the periphery to the tunable lens, the actuators may be indirect actuators. In particular, the indirect actuators may include a source for the driving force needed to move the tunable lens and a mechanism that allows an actuating component to vary the mechanical properties of the mechanism to affect the position of the load and to allow the driving force to move the tunable lens. The driving force may be a preloaded force component, such as a preloaded spring, a component with fluid pressure, a magnetic component, or another suitable component having a preloaded force. The actuating component may be a shape memory alloy (SMA) wire, a motor, a piezoelectric component, or another suitable component, and the actuating component may adjust the mechanical advantage, stiffness, or other suitable property of the mechanism, allowing the preloaded force to adjust the tunable lens. In this way, an indirect actuator may be used to adjust the tunable lens.

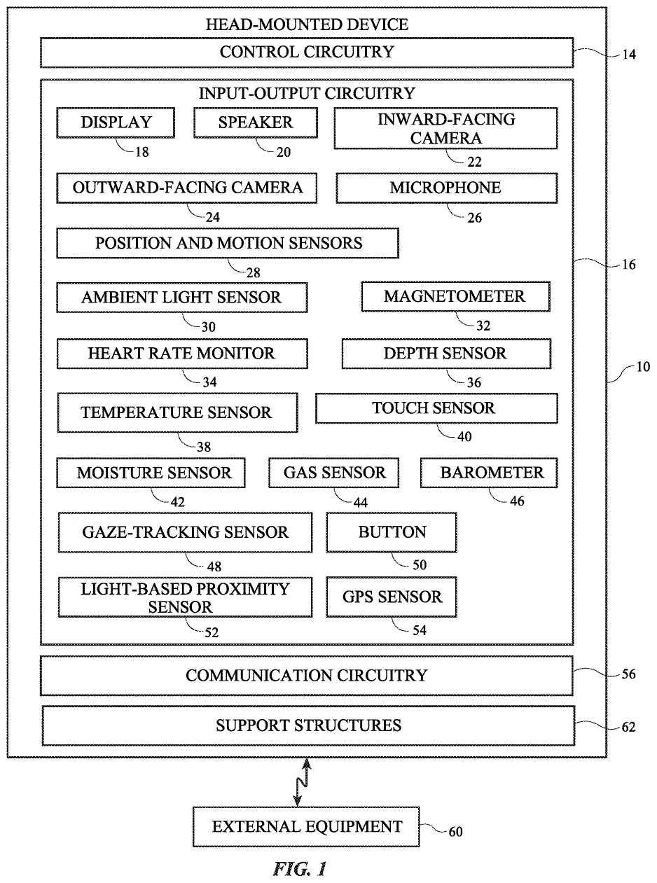

A schematic diagram of an illustrative electronic device that may include tunable lenses is shown in FIG. 1. As shown in FIG. 1, electronic device 10 (sometimes referred to as head-mounted device 10, system 10, or head-mounted display 10 herein) may have control circuitry 14. In addition to being a head-mounted device, electronic device 10 may be other types of electronic devices such as a cellular telephone, laptop computer, speaker, computer monitor, electronic watch, tablet computer, and/or one or more other suitable devices. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies herein) that allow a viewer to view images on display(s) 18. A single display 18 may produce images for both eyes, or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

The example of device 10 including a display is merely illustrative and display(s) 18 may be omitted from device 10 if desired. Device 10 may include an optical pass-through area where real-world content is viewable to the user either directly or through a tunable lens.

Input-output circuitry 16 may include various other input-output devices. For example, input-output circuitry 16 may include one or more speakers 20 that are configured to play audio and one or more microphones 26 that are configured to capture audio data from the user and/or from the physical environment around the user.

Input-output circuitry 16 may also include one or more cameras such as an inward-facing camera 22 (e.g., that face the user's face when the head-mounted device is mounted on the user's head) and an outward-facing camera 24 (that face the physical environment around the user when the head-mounted device is mounted on the user's head). Cameras 22 and 24 may capture visible light images, infrared images, or images of any other desired type. The cameras may be stereo cameras if desired. Inward-facing camera 22 may capture images that are used for gaze-detection operations, in one possible arrangement. Outward-facing camera 24 may capture pass-through video for head-mounted device 10.

As shown in FIG. 1, input-output circuitry 16 may include position and motion sensors 28 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 28, for example, control circuitry 14 can monitor the current direction in which a user's head is oriented relative to the surrounding environment (e.g., a user's head pose). One or more of cameras 22 and 24 may also be considered part of position and motion sensors 28. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16 may also include other sensors and input-output components if desired. As shown in FIG. 1, input-output circuitry 16 may include an ambient light sensor 30. The ambient light sensor may be used to measure ambient light levels around head-mounted device 10. The ambient light sensor may measure light at one or more wavelengths (e.g., different colors of visible light and/or infrared light).

Input-output circuitry 16 may include a magnetometer 32. The magnetometer may be used to measure the strength and/or direction of magnetic fields around head-mounted device 10.

Input-output circuitry 16 may include a heart rate monitor 34. The heart rate monitor may be used to measure the heart rate of a user wearing head-mounted device 10 using any desired techniques.

Input-output circuitry 16 may include a depth sensor 36. The depth sensor may be a pixelated depth sensor (e.g., that is configured to measure multiple depths across the physical environment) or a point sensor (that is configured to measure a single depth in the physical environment). The depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 16 may include a temperature sensor 38. The temperature sensor may be used to measure the temperature of a user of head-mounted device 10, the temperature of head-mounted device 10 itself, or an ambient temperature of the physical environment around head-mounted device 10.

Input-output circuitry 16 may include a touch sensor 40. The touch sensor may be, for example, a capacitive touch sensor that is configured to detect touch from a user of the head-mounted device.

Input-output circuitry 16 may include a moisture sensor 42. The moisture sensor may be used to detect the presence of moisture (e.g., water) on, in, or around the head-mounted device.

Input-output circuitry 16 may include a gas sensor 44. The gas sensor may be used to detect the presence of one or more gases (e.g., smoke, carbon monoxide, etc.) in or around the head-mounted device.

Input-output circuitry 16 may include a barometer 46. The barometer may be used to measure atmospheric pressure, which may be used to determine the elevation above sea level of the head-mounted device.

Input-output circuitry 16 may include a gaze-tracking sensor 48 (sometimes referred to as gaze-tracker 48 and gaze-tracking system 48). The gaze-tracking sensor 48 may include a camera (e.g., inward-facing camera 22) and/or other gaze-tracking sensor components (e.g., light sources that emit beams of light so that reflections of the beams from a user's eyes may be detected) to monitor the user's eyes. Gaze-tracker 48 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 48 is merely illustrative.

Input-output circuitry 16 may include a button 50. The button may include a mechanical switch that detects a user press during operation of the head-mounted device.

Input-output circuitry 16 may include a light-based proximity sensor 52. The light-based proximity sensor may include a light source (e.g., an infrared light source) and an image sensor (e.g., an infrared image sensor) configured to detect reflections of the emitted light to determine proximity to nearby objects.

Input-output circuitry 16 may include a global positioning system (GPS) sensor 54. The GPS sensor may determine location information for the head-mounted device. The GPS sensor may include one or more antennas used to receive GPS signals. The GPS sensor may be considered a part of position and motion sensors 28.

Input-output circuitry 16 may include any other desired components (e.g., capacitive proximity sensors, other proximity sensors, strain gauges, pressure sensors, audio components, haptic output devices such as vibration motors, light-emitting diodes, or other light sources).

Head-mounted device 10 may also include communication circuitry 56 to allow the head-mounted device to communicate with external equipment (e.g., a tethered computer, a portable device such as a handheld device or laptop computer, one or more external servers, or other electrical equipment). Communication circuitry 56 may be used for both wired and wireless communication with external equipment.

Communication circuitry 56 may include radio frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio frequency transceiver circuitry in wireless communication circuitry 56 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L 5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communication circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, and/or any other suitable types of antennas. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with external equipment 60. External equipment 60 may include one or more external servers, an electronic device that is paired with head-mounted device 10 (such as a cellular telephone, a laptop computer, a speaker, a computer monitor, an electronic watch, a tablet computer, earbuds, or another electronic device), a vehicle, an internet of things (IoT) device (e.g., remote control, light switch, doorbell, lock, smoke alarm, light, thermostat, oven, refrigerator, stove, grill, coffee maker, toaster, or microwave), and/or another suitable device.

Electronic device 10 may have housing structures (e.g., housing walls or straps) as shown by illustrative support structures 62 of FIG. 1. In configurations in which electronic device 10 is a head-mounted device (e.g., a pair of glasses, goggles, a helmet, a hat, etc.), support structures 62 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support control circuitry 14, input-output circuitry 16, and/or communication circuitry 56.

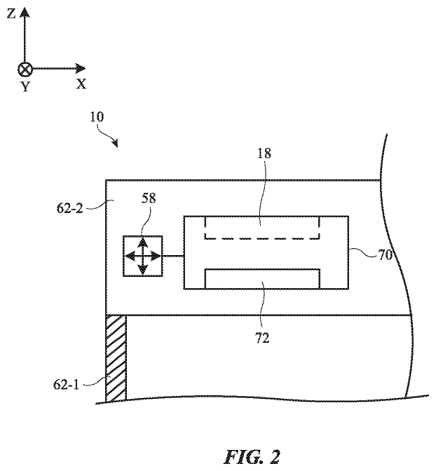

FIG. 2 is a top view of electronic device 10 in an illustrative configuration in which electronic device 10 is a head-mounted device. As shown in FIG. 2, electronic device 10 may include support structures (see, e.g., support structures 62 of FIG. 1) that are used in housing the components of device 10 and mounting device 10 onto a user's head. These support structures may include, for example, structures that form housing walls and other structures for main unit 62-2 (e.g., exterior housing walls, lens module structures, etc.) and eyeglass temples or other supplemental support structures such as structures 62-1 that help to hold main unit 62-2 on a user's face.

The electronic device may include optical modules such as optical module 70. The electronic device may include left and right optical modules that correspond respectively to a user's left eye and right eye. An optical module corresponding to the user's left eye is shown in FIG. 2.

Each optical module 70 includes a corresponding lens module 72 (sometimes referred to as lens stack-up 72, lens 72, or adjustable lens 72 herein). Lens 72 may include one or more lens elements arranged along a common axis. Each lens element may have any desired shape and may be formed from any desired material (e.g., with any desired refractive index). The lens elements may have unique shapes and refractive indices that, in combination, focus light (e.g., from a display and/or from the physical environment) in a desired manner. Each lens element of lens module 72 may be formed from any desired material (e.g., glass, a polymer material such as polycarbonate or acrylic, or a crystal such as sapphire).

Modules 70 may optionally be individually positioned relative to the user's eyes and relative to some of the housing wall structures of main unit 26-2 using positioning circuitry such as positioner 58. Positioner 58 may include stepper motors, piezoelectric actuators, motors, linear electromagnetic actuators, shape memory alloys (SMAs), and/or other electronic components for adjusting the position of displays, the optical modules 70, and/or lens modules 72. Positioners 58 may be controlled by control circuitry 14 (FIG. 1) during operation of device 10. For example, positioners 58 may be used to adjust the spacing between modules 70 (and therefore the lens-to-lens spacing between the left and right lenses of modules 70) to match the interpupillary distance IPD of a user's eyes. In another example, the lens module may include an adjustable lens element (also referred to as a tunable lens element herein). The curvature of the adjustable lens element may be adjusted in real time by positioner(s) 58 to compensate for a user's eyesight and/or viewing conditions.

Each optical module may optionally include a display such as display 18 in FIG. 2. As previously mentioned, the displays may be omitted from device 10 if desired. In this type of arrangement, the device may still include one or more lens modules 72 (e.g., through which the user views the real world). In this type of arrangement, real-world content may be selectively focused for a user.

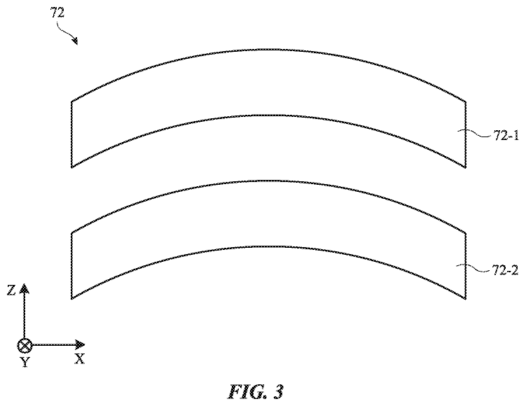

FIG. 3 is a cross-sectional side view of an illustrative lens module with multiple lens elements. As shown, lens module 72 includes a first lens element 72-1 and a second lens element 72-2. Each surface of the lens elements may have any desired curvature. For example, each surface may be a convex surface (e.g., a spherically convex surface, a cylindrically convex surface, or an aspherically convex surface), a concave surface (e.g., a spherically concave surface, a cylindrically concave surface, or an aspherically concave surface), a combination of convex and concave surfaces, or a freeform surface. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. A freeform surface may include both convex and concave portions and/or curvatures defined by polynomial series and expansions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In one example, shown in FIG. 3, lens element 72-1 has a convex surface that faces display 18 and an opposing concave surface. Lens element 72-2 has a convex surface that faces lens element 72-1 and an opposing concave surface.

One or both of lens elements 72-1 and 72-2 may be adjustable (also referred to as tunable herein). In one example, lens element 72-1 is a non-adjustable lens element whereas lens element 72-2 is an adjustable lens element. The adjustable lens element 72-2 may be used to accommodate a user's eyeglass prescription, for example. The shape of lens element 72-2 may be adjusted if a user's eyeglass prescription changes (without needing to replace any of the other components within device 10). As another possible use case, a first user with a first eyeglass prescription (or no eyeglass prescription) may use device 10 with lens element 72-2 having a first shape and a second, different user with a second eyeglass prescription may use device 10 with lens element 72-2 having a second shape that is different than the first shape. Lens element 72-2 may have varying lens power and/or may provide varying amounts and orientations of astigmatism correction to provide prescription correction for the user.

The example of lens module 72 including two lens elements is merely illustrative. In general, lens module 72 may include any desired number of lens elements (e.g., one, two, three, four, more than four, etc.). Any subset or all of the lens elements may optionally be adjustable. Any of the adjustable lens elements in the lens module may optionally be fluid-filled adjustable lenses. Lens module 72 may also include any desired additional optical layers (e.g., partially reflective mirrors that reflect 50% of incident light, linear polarizers, retarders such as quarter wave plates, reflective polarizers, circular polarizers, and/or reflective circular polarizers) to manipulate light that passes through lens module.

In one possible arrangement, lens element 72-1 may be a removable lens element. In other words, a user may be able to easily remove and replace lens element 72-1 within optical module 70. This may allow lens element 72-1 to be customizable. If lens element 72-1 is permanently affixed to the lens assembly, the lens power provided by lens element 72-1 cannot be easily changed. However, by making lens element 72-1 customizable, a user may select a lens element 72-1 that best suits their eyes and place the appropriate lens element 72-1 in the lens assembly. The lens element 72-1 may be used to accommodate a user's eyeglass prescription, for example. A user may replace lens element 72-1 with an updated lens element if their eyeglass prescription changes (without needing to replace any of the other components within electronic device 10). Lens element 72-1 may have varying lens power and/or may provide varying amount of astigmatism correction to provide prescription correction for the user. Lens element 72-1 may include one or more attachment structures that are configured to attach to corresponding attachment structures included in optical module 70, lens element 72-2, support structures 62, or another structure in electronic device 10.

In contrast with lens element 72-1, lens element 72-2 may not be a removable lens element. Lens element 72-2 may therefore sometimes be referred to as a permanent lens element or a non-removable lens element herein. The example of lens element 72-2 being a non-removable lens element is merely illustrative. In another possible arrangement, lens element 72-2 may also be a removable lens element (similar to lens element 72-1).

As previously mentioned, one or more of the adjustable lens elements may be a fluid-filled lens element. An example is described herein where lens element 72-2 from FIG. 3 is a fluid-filled lens element. When lens element 72-2 is a fluid-filled lens element, the lens element may include one or more components that define the surfaces of lens element 72-2. These components may also be referred to as lens elements. In other words, adjustable lens element 72-2 (sometimes referred to as adjustable lens module 72-2, adjustable lens 72-2, or tunable lens 72-2 herein) may be formed by multiple respective lens elements.

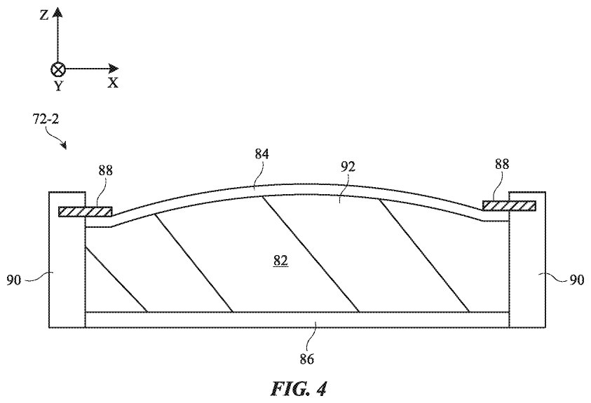

FIG. 4 is a cross-sectional side view of illustrative adjustable fluid-filled lens element 72-2. As shown, fluid-filled chamber 82 (sometimes referred to as chamber 82, fluid chamber 82, or primary chamber 82 herein) that includes fluid 92 is interposed between lens elements 84 and 86. Lens elements 84 and 86 may sometimes be referred to as part of chamber 82 or may sometimes be referred to as separate from chamber 82. Fluid 92 may be a liquid, gel, or gas with a pre-determined index of refraction (and may therefore sometimes be referred to as liquid 92, gel 92, or gas 92 herein). The fluid may sometimes be referred to as an index-matching oil, an optical oil, an optical fluid, an index-matching material, or an index-matching liquid. Lens elements 84 and 86 may have the same index of refraction or may have different indices of refraction. Fluid 92 that fills chamber 82 between lens elements 84 and 86 may have an index of refraction that is the same as the index of refraction of lens element 84 but different from the index of refraction of lens element 86, may have an index of refraction that is the same as the index of refraction of lens element 86 but different from the index of refraction of lens element 84, may have an index of refraction that is the same as the index of refraction of lens element 84 and lens element 86, or may have an index of refraction that is different from the index of refraction of lens element 84 and lens element 86. Lens elements 84 and 86 may have a circular footprint, may have an elliptical footprint, or may have a footprint any another desired shape (e.g., an irregular footprint).

The amount of fluid 92 in chamber 82 may have a constant volume or an adjustable volume. If the amount of fluid is adjustable, the lens module may also include a fluid reservoir and a fluid controlling component (e.g., a pump, stepper motor, piezoelectric actuator, shape memory alloy (SMA), motor, linear electromagnetic actuator, and/or other electronic component that applies a force to the fluid in the fluid reservoir) for selectively transferring fluid between the fluid reservoir and the chamber.

Lens elements 84 and 86 may be transparent lens elements formed from any desired material (e.g., glass, a polymer material such as polycarbonate or acrylic, a crystal such as sapphire, etc.). Each one of lens elements 84 and 86 may be elastomeric, semi-rigid, or rigid. In one example, lens element 84 is an elastomeric lens element whereas lens element 86 is a rigid lens element.

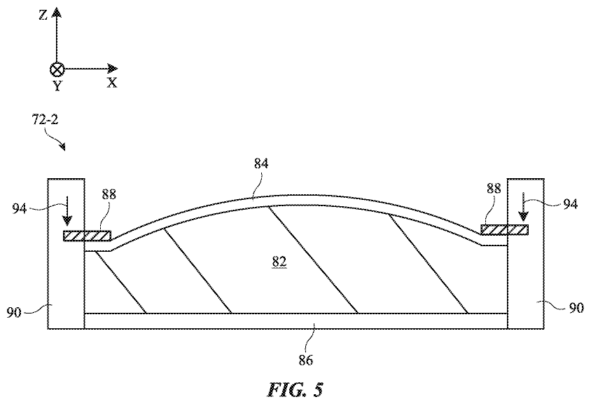

Elastomeric lens elements (e.g., lens element 84 in FIGS. 4 and 5) may be formed from a natural or synthetic polymer that has a low Young's modulus for high flexibility. For example, the elastomeric membrane may be formed from a material having a Young's modulus of less than 1 GPa, less than 0.5 GPa, or less than 0.1 GPa, as examples.

Semi-rigid lens elements may be formed from a semi-rigid material that is stiff and solid, but not inflexible. A semi-rigid lens element may, for example, be formed from a thin layer of polymer or glass. Semi-rigid lens elements may be formed from a material having a Young's modulus that is greater than 1 Gpa, greater than 2 GPa, greater than 3 GPa, greater than 10 GPa, or greater than 25 GPa, as examples. Semi-rigid lens elements may be formed from polycarbonate, polyethylene terephthalate (PET), polymethylmethacrylate (PMMA), acrylic, glass, or any other desired material. The properties of semi-rigid lens elements may result in the lens element becoming rigid along a first axis when the lens element is curved along a second axis perpendicular to the first axis or, more generally, for the product of the curvature along its two principal axes of curvature to remain roughly constant as it flexes. This is in contrast to an elastomeric lens element, which remains flexible along a first axis even when the lens element is curved along a second axis perpendicular to the first axis. The properties of semi-rigid lens elements may allow the semi-rigid lens elements to form a cylindrical lens with tunable lens power and a tunable axis.

Rigid lens elements (e.g., lens element 86 in FIGS. 4 and 5) may be formed from glass, a polymer material such as polycarbonate or acrylic, a crystal such as sapphire, and/or another suitable material. In general, the rigid lens elements may not deform when pressure is applied to the lens elements within the lens module. In other words, the shape and position of the rigid lens elements may be fixed. Each surface of a rigid lens element may be planar, concave (e.g., spherically, aspherically, or cylindrically concave), or convex (e.g., spherically, aspherically, or cylindrically convex). Rigid lens elements may be formed from a material having a Young's modulus that is greater than greater than 25 GPa, greater than 30 GPa, greater than 40 GPa, or greater than 50 GPa, as examples.

In addition to lens elements 84 and 86 and fluid-filled chamber 82, lens module 72-2 also includes a lens shaping element 88. Lens shaping element 88 may be coupled to one or more actuators 90 (e.g., positioned around the circumference of the lens module). The lens shaping element 88 may also be coupled to lens element 84. Actuators 90 may be adjusted to adjust the position of lens shaping element 88 (sometimes referred to as lens shaper 88, deformable lens shaper 88, lens shaping structure 88, lens shaping member 88, annular member 88, or ring-shaped structure 88 herein). The lens shaping element 88 in turn manipulates the positioning/shape of lens element 84. In this way, the curvature of the lens element 84 (and accordingly, the lens power and/or other optical properties of lens module 72-2) may be adjusted. An example of actuators 90 and lens shaper 88 being used to change the curvature of lens element 84 in FIG. 5. As shown, lens shaper 88 is moved in direction 94 by actuators 90. This results in lens element 84 having more curvature in FIG. 5 than in FIG. 4.

The example of tunable lens element 72-2 being a fluid-filled lens element is merely illustrative. In general, tunable lens element 72-2 may be any desired type of tunable lens element with adjustable optical power.

The shape (and corresponding optical power) of tunable lens element 72-2 may be adjusted in response to information from any of the components in input-output circuitry 16 (FIG. 1).

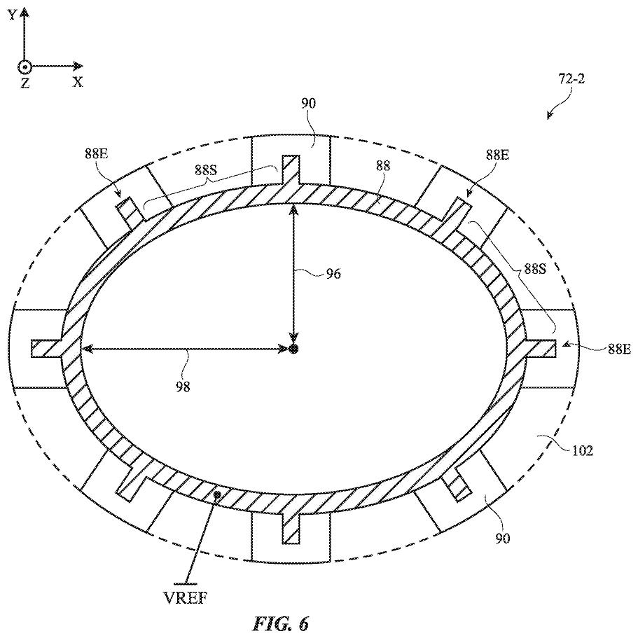

FIG. 6 is a top view of an illustrative lens shaping element 88. As shown, lens shaping element 88 may have an annular or ring shape with the lens shaping element surrounding a central opening. The lens shaping element may have any desired shape. For example, the lens shaping element may be circular, elliptical, or have an irregular shape. In the example of FIG. 6, the lens shaping element has an elliptical shape (e.g., a non-uniform radius around the ring shape). For example, a first distance 96 (e.g., a minimum distance) from the center of the central opening to the edge of the lens shaping element may be smaller than a second distance 98 (e.g., a maximum distance) from the center of the central opening to the edge of the lens shaping element. Distance 96 and 98 may each be less than 100 millimeters, less than 60 millimeters, less than 40 millimeters, less than 30 millimeters, greater than 10 millimeters, greater than 20 millimeters, between 10 and 50 millimeters, or other suitable distances.

Lens shaping element 88 may have a plurality of tabs 88E that extend from the main portion of the lens shaping element. The tabs 88E (sometimes referred to as extensions 88E or actuator points 88E herein) may each be coupled to a respective actuator 90. Each actuator may selectively move its respective extension 88E up and down (e.g., in the Z-direction) to control the position of tab 88E in the Z-direction.

Although FIG. 6 shows each tab 88E coupled to an actuator 90, this is merely illustrative. In some embodiments, some of actuators 90 may be replaced by counterbalance mechanisms. The counterbalance mechanisms may be passive counterbalance mechanisms that include springs and/or other structures that move the associated tabs 88E when neighboring actuators 90 are adjusted. For example, the passive counterbalance mechanisms may adjust the associated tabs 88E to follow the actuator profile curve set by actuators 90. In this way, fewer actuators 90 may be used.

FIG. 6 shows how a plurality of tabs 88E (and corresponding actuators) may be distributed around the perimeter of lens shaping element 88. Tabs 88E may be distributed around lens shaping element 88 in a uniform manner (e.g., with equal spacing between each pair of adjacent tabs 88E) or in a non-uniform manner (e.g., with unequal spacing between at least two of the adjacent tabs 88E).

Between each pair of adjacent tabs 88E, there is a lens shaper segment 88S. In the example of FIG. 6, there are 8 tabs 88E and 8 actuators 90 around the perimeter of lens shaping element 88. This example is merely illustrative. In general, more tabs (and corresponding actuators) may allow for greater control of the shape of the lens element (e.g., lens element 84) to which lens shaping element 88 is coupled. Any desired number of tabs and actuators (e.g., one, two, three, four, more than four, more than six, more than eight, more than ten, more than twelve, more than twenty, less than twenty, less than ten, between four and twelve, etc.) may be used depending upon the specific target shapes for the lens element, the target cost/complexity of the lens module, etc.

Lens shaping element 88 may be elastomeric (e.g., a natural or synthetic polymer that has a low Young's modulus for high flexibility, as discussed above in connection with FIGS. 4 and 5) or semi-rigid (e.g., formed from a semi-rigid material that is stiff and solid, but not inflexible, as discussed above in connection with FIGS. 4 and 5). A semi-rigid lens shaping element may, for example, be formed from a thin layer of polymer, glass, metal, etc. Because lens shaping element 88 is formed in a ring around the lens module, lens shaping element 88 does not need to be transparent (and therefore may be formed from an opaque material such as metal, if desired). The rigidity of lens shaping element 88 may be selected such that the lens shaping element assumes desired target shapes when manipulated by the actuators around its perimeter.

One or more structures such as a lens housing 102 (sometimes referred to as housing 102, lens chassis 102, chassis 102, support structure 102, bezel 102, ring-shaped housing 102, or ring-shaped chassis 102 herein) may also be included in tunable lens element 72-2. Actuators 90 may be positioned within lens housing 102. Lens housing 102 may optionally define a portion of the fluid-filled chamber 82. Lens housing 102 may extend in a ring around the periphery of the tunable lens.

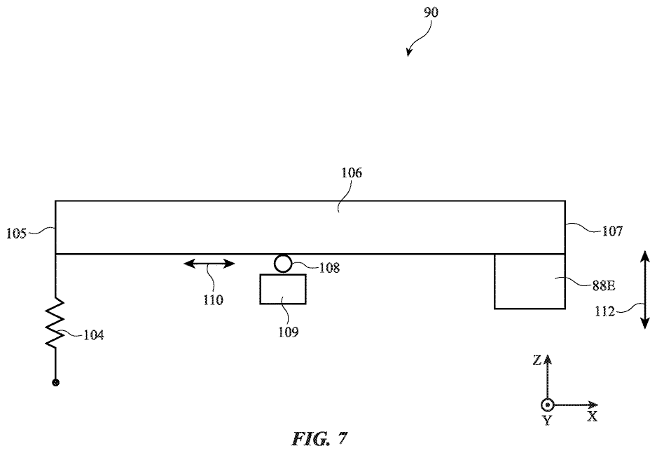

In some embodiments, one or more actuators 90 may be indirect actuators. The indirect actuator(s) may include a preloaded force component that is used to move extensions 88E of lens shaping element 88 as an adjustment mechanism is moved or otherwise adjusted by an actuating component. An illustrative example is shown in FIG. 7.

As shown in FIG. 7, actuator 90 may include preloaded force component 104 coupled to first end 105 of lever 106. Preloaded force component 104 is shown in FIG. 7 as a spring (e.g., a preloaded spring), which may be a compression spring, a tension spring, a torsion spring, or another suitable spring. However, the use of a spring for preloaded force component 104 is merely illustrative. In general, preloaded force component 104 may be a fluid-filled component to provide fluid pressure (e.g., hydraulics), a magnetic component to provide a magnetic force, or any other suitable preloaded force component. Lever 106 may be formed from metal, plastic, or another suitable material.

Extension 88E may be coupled to second end 107 of lever 106, opposite first end 105. Lever 106 may rotate about pivot 108, which may be a metal rod, a plastic rod, or another suitable material and pivot structure.

In operation, actuating component 109, which may include one or more shape memory alloy (SMA) wires, motors, magnets, hydraulic actuators, and/or any other suitable actuators, may move pivot 108 in directions 110 (e.g., in the +X and −X directions). In response, extension 88E may move in directions 112 (e.g., in the +Z and −Z directions) due to the preloaded force from preloaded force component 104. In other words, lever 106 may initially be at an equilibrium, and the movement of pivot 108 in one of directions 110 will result in a corresponding movement of extension 88E in one of directions 112 due to preloaded force component 104. In this way, extension 88E (and therefore lens shaping element 88) may be adjusted using the preloaded force from preloaded force component 104, resulting in less energy needed to adjust extension 88E.

Although FIG. 7 shows lever 106 as a first-class lever, this is merely illustrative. In general, lever 106 may second-class lever or a third-class lever, if desired.

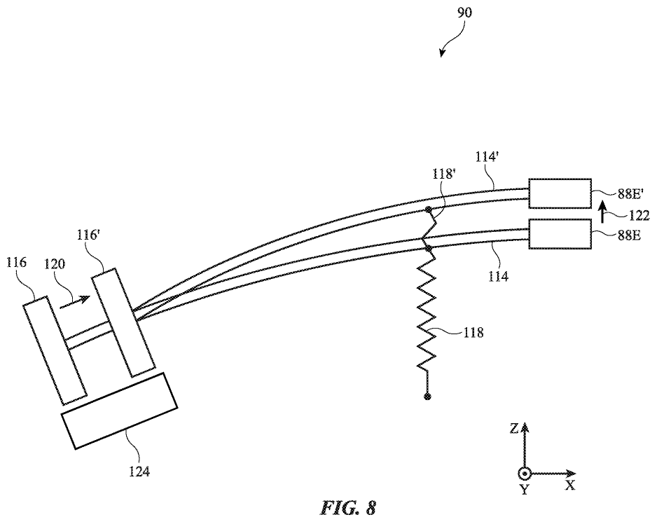

In some embodiments, a preloaded cantilever beam may be used as an indirect actuator for lens shaping element 88. An illustrative example is shown in FIG. 8.

As shown in FIG. 8, actuator 90 may include cantilever beam 114 with a first end coupled to adjustment mechanism 116 and an opposing second end coupled to preloaded force component 118. Extension 88E may be coupled to the second end of cantilever beam 114, adjacent to preloaded force component 118.

Cantilever beam 114 may be formed from metal, plastic, or another suitable material. Adjustment mechanism 116 may be a solid component to which the first end of cantilever beam 114 is fixed and may be formed from metal, plastic, or another suitable material. Preloaded force component 118 is shown in FIG. 8 as a spring (e.g., a preloaded spring), which may be a compression spring, a tension spring, a torsion spring, or another suitable spring. However, the use of a spring for preloaded force component 118 is merely illustrative. In general, preloaded force component 118 may be a fluid-filled component to provide fluid pressure (e.g., hydraulics), a magnetic component to provide a magnetic force, or any other suitable preloaded force component.

In operation, actuating component 124, which may include one or more shape memory alloy (SMA) wires, motors, magnets, hydraulic actuators, and/or any other suitable actuators, may move adjustment mechanism 116 in direction 120 to position 116′. In response, cantilever beam 114 may be moved to position 114′ by preloaded force component 118, and extension 88E may move in direction 122 (e.g., the +Z direction) to position 88E′. In other words, cantilever beam 114 may initially be at an equilibrium, and the movement of adjustment mechanism 116 in direction 120 will result in a corresponding movement of extension 88E in direction 122. In this way, extension 88E (and therefore lens shaping element 88) may be adjusted using the preloaded force from preloaded force component 118, resulting in less energy needed to adjust extension 88E.

Although FIG. 8 shows adjustment mechanism 116 being moved in direction 120 to move extension 88E in direction 122, this is merely illustrative. Adjustment mechanism 116 may be moved in a direction opposite to direction 120 to move extension 88E in a direction opposite to direction 122, if desired. Alternatively or additionally, depending on the biasing direction of preloaded force component 118, extension 88E may move in the direction opposite direction 122 in response to the movement of adjustment mechanism 116 in direction 120.

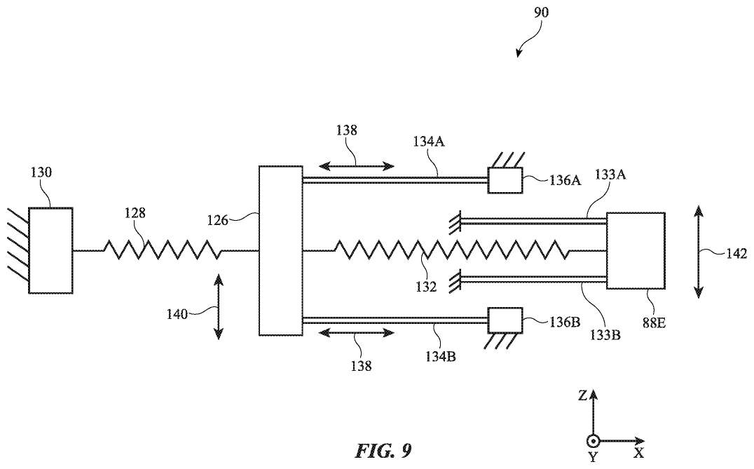

In some embodiments, multiple preloaded force components may be included in an indirect actuator for lens shaping element 88. An illustrative example is shown in FIG. 9.

As shown in FIG. 9, actuator 90 may include adjustment mechanism 126 and first preloaded force component 132 coupled to adjustment mechanism 126 and to extension 88E. Second preloaded force component 128 may be coupled between adjustment mechanism 126 and fixed location 130 (e.g., a portion of the housing or another fixed location). Adjustment mechanism 126 may be a solid component to which the ends of preloaded force components 128 and 132 are fixed and may be formed from metal, plastic, or another suitable material. In the example of FIG. 9, first preloaded force component 132 may be a compression spring, and second preloaded force component 128 may be a tension spring. However, this is merely illustrative. In general, preloaded force components 128 and 132 may be any types of springs, such as compression, tension, and/or torsion springs, and/or may be fluid-filled components to provide fluid pressure (e.g., hydraulics), magnetic components to provide a magnetic force, or any other suitable preloaded force components.

Adjustment mechanism 126 may be coupled to actuating components 134A and 134B. In the illustrative example of FIG. 9, actuating components 134A and 134B are SMA wires that are anchored at fixed locations 136A and 136B (e.g., portions of the housing or other fixed locations). Therefore, actuating components 134A and 134B may be referred to as SMA wires 134A and 134B herein. However, this is merely illustrative. In general, adjustment mechanism 126 may be coupled to any suitable actuating mechanism(s), such as one or more motors, magnets, hydraulic actuators, and/or any other suitable actuators.

Optionally, in addition to being coupled to an end of preloaded force component 132, extension 88E may be coupled to one or more constraints, such as vertical constraint flexures 133A and 133B. Vertical constraint flexures 133A and 133B may be formed from polymer, elastomer, or another suitable material, and may be coupled between extension 88E and a fixed location (e.g., a portion of the housing or another fixed point). In this way, vertical constraint flexures 133A and 133B may constrain the movement of extension 88E. However, the use of vertical constraint flexures 133A and 133B to constrain the movement of extension 88E is merely illustrative. In general, any suitable constraint may be used to constrain the movement of extension 88E in one or more desired directions.

In operation, SMA wires 134A and 134B (and/or any other suitable actuating component(s)) may be contracted or extended in directions 138 (e.g., in the +X and −X directions). In response, adjustment mechanism 126 will move in directions 140 (e.g., in the +Z and −Z directions), which in turn will move extension 88E in directions 142 (e.g., in the +Z and −Z directions). In other words, adjustment mechanism 126 and extension 88E may initially be at an equilibrium, and the movement of adjustment mechanism 126 in directions 140 will result in a corresponding movement of extension 88E in directions 142 (e.g., opposite the direction of movement of adjustment mechanism 126 in the example of FIG. 9). In this way, extension 88E (and therefore lens shaping element 88) may be adjusted using the preloaded force from preloaded force components 128 and 132, resulting in less energy needed to adjust extension 88E.

In the example of FIG. 9, preloaded force component 132 may be a preloaded compression spring, and preloaded force component 128 may be a preloaded tension spring. However, this is merely illustrative. In general, preloaded force components 132 and 128 may be any suitable types of springs or other preloaded force components. In some illustrative examples, preloaded force component 132 may be a tension spring instead of a compression spring. As a result, actuator 90 may include additional anchor points and/or structures for extension 88E, but extension 88E may still be adjusted by moving adjustment mechanism 126.

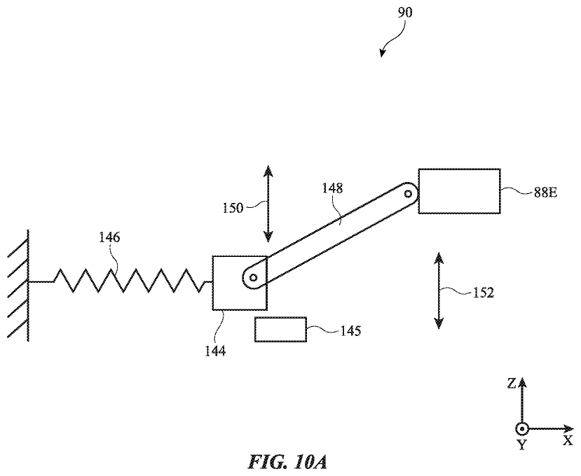

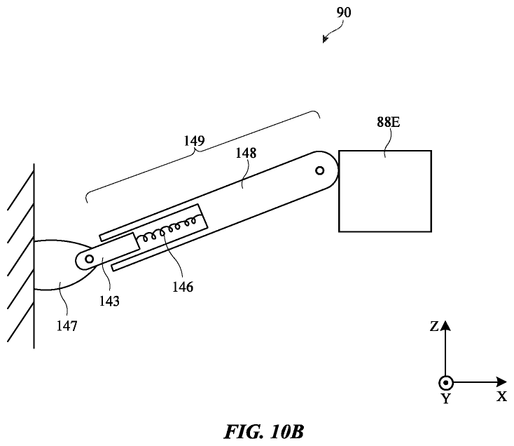

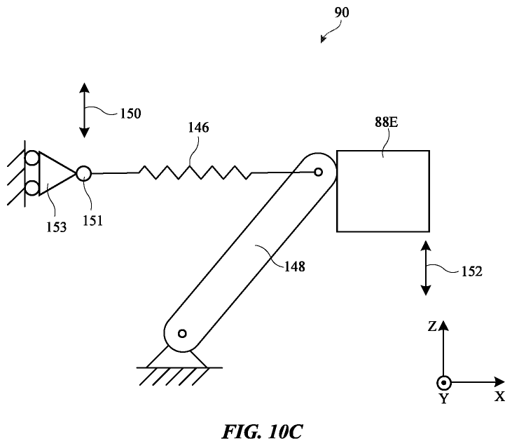

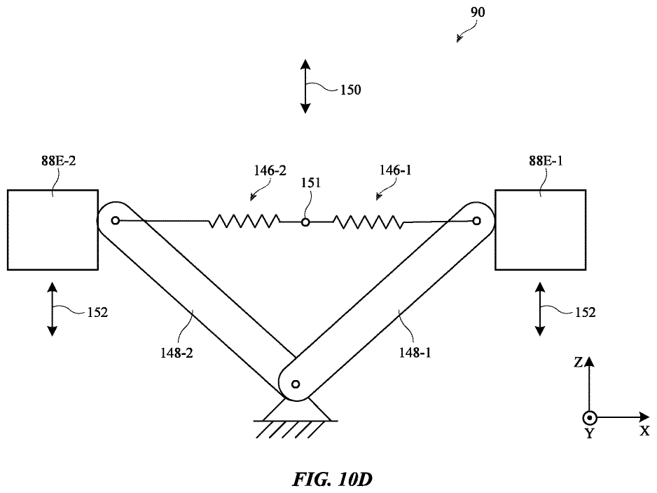

Another illustrative indirect actuator that may be used to adjust lens shaping element 88 is shown in FIG. 10A. As shown in FIG. 10A, actuator 90 may include adjustment mechanism 144 coupled to preloaded force component 146 and to extension 88E via arm 148. Adjustment mechanism 144 may be a solid component and may be formed from metal, plastic, or another suitable material. In the example of FIG. 10A, preloaded force component 146 may be a preloaded spring, such as a compression spring, a tension spring, or a torsion spring. However, this is merely illustrative. In general, preloaded force component 146 may be a fluid-filled component to provide fluid pressure (e.g., hydraulics), a magnetic component to provide a magnetic force, or any other suitable preloaded force component. Arm 148 may be a solid component and may be formed from metal plastic, or another suitable material.

In operation, actuating component 145, which may be one or more shape memory alloy (SMA) wires, motors, magnets, hydraulic actuators, and/or any other suitable actuators, may move adjustment mechanism 144 in directions 150 (e.g., in the +Z and −Z directions). In response, extension 88E may move in directions 152 (e.g., in the +Z and −Z directions) opposite the direction in which adjustment mechanism 144 is moved. In other words, adjustment mechanism 144 and extension 88E may initially be at an equilibrium, and the movement of adjustment mechanism 144 in directions 150 will result in a corresponding movement of extension 88E in directions 152 (in the opposite direction of the movement of adjustment mechanism 144). In this way, extension 88E (and therefore lens shaping element 88) may be adjusted using the preloaded force from preloaded force component 146, resulting in less energy needed to adjust extension 88E.

Although FIG. 10A shows actuator 90 including preloaded force component 146 and arm 148 formed separately from one another, this is merely illustrative. In some embodiments, preloaded force component 146 and arm 148 may be combined into one component. An illustrative example is shown in FIG. 10B.

As shown in FIG. 10B, preloaded force component 146 and arm 148 may be formed together in component 149. Component 149 may be coupled to fixed member 147 with pivot 143. In this way, an actuating component (e.g., actuating component 145 of FIG. 10) may adjust the position of extension 88E using the preloaded force from preloaded force component 146.

Another illustrative indirect actuator that may be sued to adjust lens shaping element 88 is shown in FIG. 10C. As shown in FIG. 10C, an end of preloaded force component 146 (e.g., a preloaded tension spring) and an end of arm 148 may be coupled to extension 88E. An opposing end of arm 148 may be rotatable about a fixed point, while an opposing end of preloaded force component 146 may be coupled to actuation point 151 and roller bearing 153 (or another movable/slidable component).

In operation, actuation point 151 may be moved in directions 150 (e.g., using an actuating component such as actuating component 145 of FIG. 10A). Therefore, the resultant moment of preloaded force component 146 will change, which in turn will move extension 88E in directions 152. In this way, extension 88E (and therefore lens shaping element 88) may be adjusted using the preloaded force from preloaded force component 146, resulting in less energy needed to adjust extension 88E.

Although FIG. 10C shows preloaded force component 146 coupled to roller bearing 153, this is merely illustrative. In some embodiments, as shown in the illustrative example of FIG. 10D, the preloaded force component 146-1 may be coupled to a mirrored mechanism through preloaded force component 146-2. The mirrored mechanism may include arm 148-2 and may be coupled to a second extension 88E-1. By moving actuation point 151 in directions 150, both extensions 88E-1 and 88E-2 may be moved in directions 152.

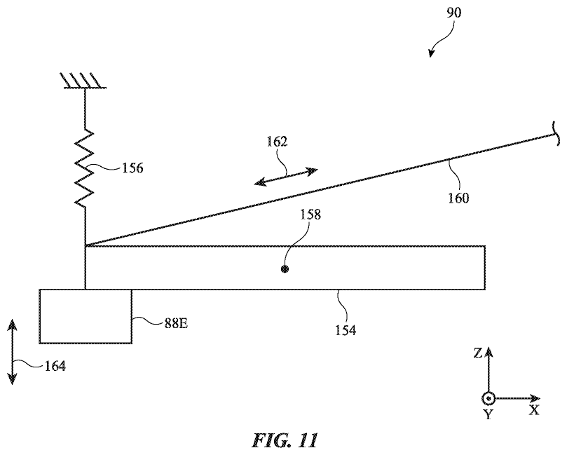

Another illustrative indirect actuator that may be used to adjust lens shaping element 88 is shown in FIG. 11. As shown in FIG. 11, actuator 90 may include adjustment mechanism 154 coupled to preloaded force component 156 and to extension 88E at a common end of adjustment mechanism 154. Adjustment mechanism 154 may be a solid component and may be formed from metal, plastic, or another suitable material. In the example of FIG. 11, adjustment mechanism 154 is a lever that is configured to pivot about pivot point 158.

In the example of FIG. 11, preloaded force component 156 may be a preloaded spring, such as a compression spring, a tension spring, or a torsion spring. However, this is merely illustrative. In general, preloaded force component 156 may be a fluid-filled component to provide fluid pressure (e.g., hydraulics), a magnetic component to provide a magnetic force, or any other suitable preloaded force component.

Actuating component 160 may be coupled to the end of adjustment mechanism 154 that is coupled to preloaded force component 156 and to extension 88E. In the example of FIG. 11, actuating component 160 includes a wire, such as a metal wire, that may be tensioned (pulled) by a motor. However, this is merely illustrative. In some embodiments, actuating component 160 may include one or more shape memory alloy (SMA) wires, motors, magnets, hydraulic actuators, and/or any other suitable actuators.

In operation, actuating component 160 may be moved in directions 162, which may move the end of adjustment mechanism 154 about pivot point 158. In response, extension 88E may move in directions 164 (e.g., in the +Z and −Z directions). For example, if actuating component 160 is pulled (to the right in FIG. 11), then extension 88E may move in the +Z direction. If actuating component 160 is released (to the left in FIG. 11), then extension 88E may move in the−Z direction. In other words, adjustment mechanism 154 and extension 88E may initially be at an equilibrium due to the tension of actuating component 160 on adjustment mechanism 154, and the movement of actuating component 160 in directions 162 will result in a corresponding movement of extension 88E in directions 164. In this way, extension 88E (and therefore lens shaping element 88) may be adjusted using the preloaded force from preloaded force component 156, resulting in less energy needed to adjust extension 88E.

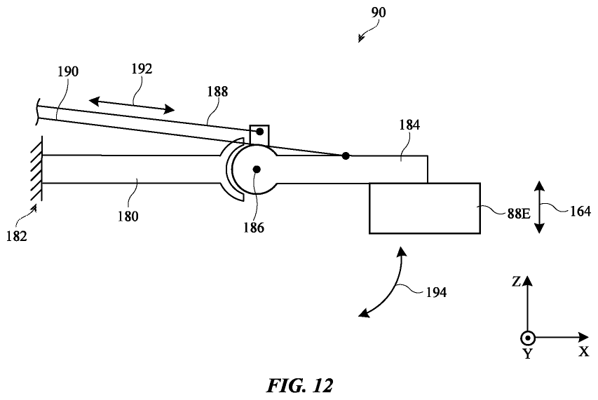

Another illustrative indirect actuator that may be used to adjust lens shaping element 88 is shown in FIG. 12. In the example of FIG. 12, actuator 90 is a pivot about a rotating joint, such as a sliding pin joint or a ball and socket joint. Actuator 90 may include adjustment mechanism 184 (e.g., the “ball”) coupled to socket 180, which may have fixed position 182. Adjustment mechanism 184 and socket 180 may be solid components and may be formed from metal, plastic, or another suitable material. In the example of FIG. 12, adjustment mechanism 184 is configured to pivot about pivot point 186.

Adjustment mechanism 184 may be coupled to actuating component 188 and preloaded force component 190. Preloaded force component 190 may be a preloaded spring, such as a compression spring, a tension spring, or a torsion spring. However, this is merely illustrative. In general, preloaded force component 190 may be a fluid-filled component to provide fluid pressure (e.g., hydraulics), a magnetic component to provide a magnetic force, or any other suitable preloaded force component.

Actuating component 188 may be coupled to the adjustment mechanism 184 near socket 180 and pivot point 186. In the example of FIG. 12, actuating component 188 includes a wire, such as a metal wire, that may be tensioned (pulled) by a motor. However, this is merely illustrative. In some embodiments, actuating component 188 may include one or more shape memory alloy (SMA) wires, motors, magnets, hydraulic actuators, and/or any other suitable actuators.

Extension 88E may be coupled to an end of adjustment mechanism 184, opposite socket 180. In operation, actuating component 188 may be moved in directions 192, which may move adjustment mechanism 184 about pivot point 186 in directions 194. In response, extension 88E may move in directions 164 (e.g., in the +Z and −Z directions). For example, if actuating component 188 is pulled (to the left in FIG. 12), then extension 88E may move in the +Z direction. If actuating component 188 is released (to the right in FIG. 12), then extension 88E may move in the −Z direction. In other words, adjustment mechanism 184 and extension 88E may initially be at an equilibrium due to the tension of preloaded for component 190 on adjustment mechanism 184, and the movement of actuating component 188 in directions 192 will result in a corresponding movement of extension 88E in directions 164. In this way, extension 88E (and therefore lens shaping element 88) may be adjusted using the preloaded force from preloaded force component 190, resulting in less energy needed to adjust extension 88E.

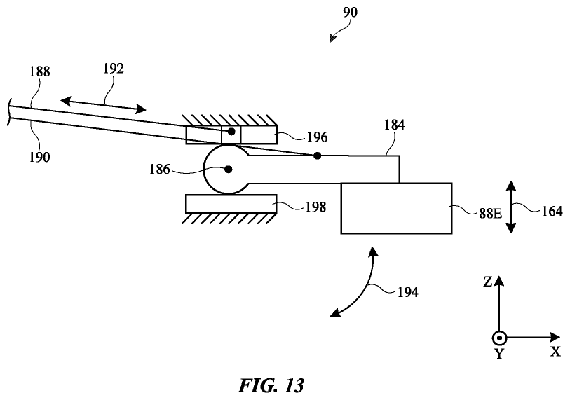

In some embodiments, it may be desirable to replace the rotating mechanism with a tension pivot. An illustrative example is shown in FIG. 13.

As shown in FIG. 13, adjustment mechanism 184 may be coupled between tension pivot and sliding joint components 196 and 198. Tension pivot and sliding joint components 196 and 198 may help maintain the position of adjustment mechanism 184 when it is at equilibrium and/or when adjustment mechanism 184 is being moved (e.g., by preloaded force component 190 and/or actuating component 188). Otherwise, actuator 90 of FIG. 13 may operate in the same manner as discussed above in connection with claim 12.

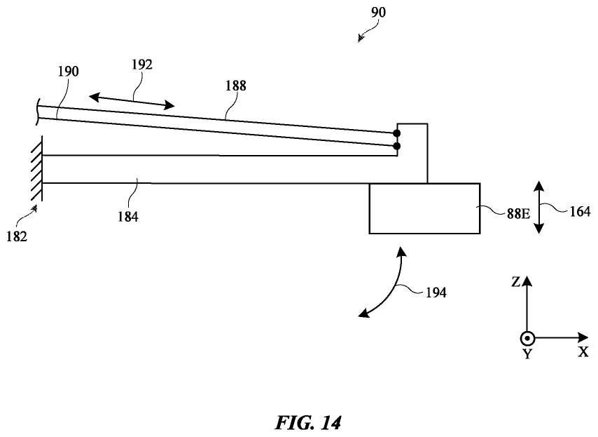

In some embodiments, adjustment mechanism 184 may be formed from a flexure that allows extension 88E to be moved. As shown in the illustrative example of FIG. 14, adjustment mechanism 184 is formed from a flexure that is fixed at position 182. Actuating component 188 may maintain the position of adjustment mechanism, or may be moved in directions 192 to pivot flexure 184 in directions 194 (e.g., due to the force exerted by preloaded force component 190). Therefore, extension 88E will move in directions 164.

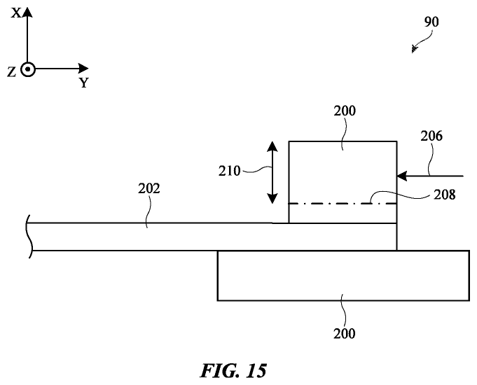

In some embodiments, actuator 90 and/or extension 88E may be braked. For example, a brake may press against a portion of actuator 90 (such as the adjustment mechanism) and/or extension 88E to stop extension 88E when it is desired to maintain the position of extension 88E. The brake may include any suitable components. In some embodiments, a piezoelectric element may be used to brake actuator 90 and/or extension 88E. An illustrative example is shown in FIG. 15.

As shown in FIG. 15, actuator 90 may include adjustment mechanism 202, which may correspond with the adjustment mechanism of any of the indirect actuators in FIGS. 7-14. Although not shown in FIG. 15, extension 88E may be coupled to adjustment mechanism 202.

As discussed above in connection with FIGS. 7-14, adjustment mechanism 202 (and therefore extension 88E) may be adjusted in the Z-direction. To stop the movement of adjustment mechanism 202 (and therefore extension 88E) when extension 88E is in a desired position, adjustment mechanism 202 may be between piezoelectric brake 200 and support 204. Support 204 may be a portion of lens housing 102 (FIG. 6) or another stationary structure.

Piezoelectric element 200 may be preloaded against adjustment mechanism 202. In other words, piezoelectric element 200 may be in contact with adjustment mechanism 202 to maintain the position of adjustment mechanism 202 (and therefore extension 88E). When it is desired to adjust adjustment mechanism 202 (and therefore extension 88E), piezoelectric element 200 may be driven by input drive signal 206 (e.g., an input voltage) to move piezoelectric element 200 in directions 210 to position 208. Therefore, piezoelectric element 200 may be moved out of contact with adjustment mechanism 202, thereby allowing adjustment mechanism 202 (and therefore extension 88E) to be moved. In general, a single tunable lens (e.g., lens 72-2 of FIG. 6) may include one or more types of indirect actuators (e.g., one or more of the indirect actuators shown in FIGS. 7-15). For example, each actuator 90 in tunable lens 72-2 may be an indirect actuator, and all of the indirect actuators may be the same type, or some of the indirect actuators may be different types.

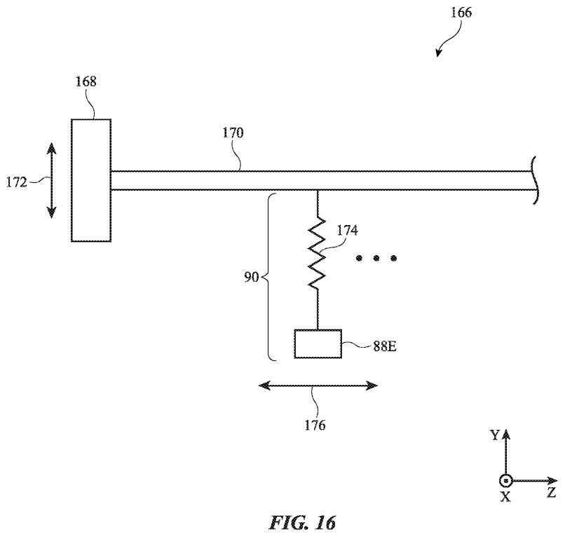

Regardless of the types of indirect actuator(s) used in a tunable lens, multiple indirect actuators may be coupled to a global adjuster. An illustrative example is shown in FIG. 16.

As shown in FIG. 16, actuator 166 may include global actuator 168 that is coupled to multiple indirect actuators 90. As discussed above in connection with FIGS. 7-15, each indirect actuator 90 may include a preloaded force component (shown in FIG. 16 as preloaded force component 174) (e.g., a spring) that is coupled to extension 88E. The preloaded force from preloaded force component 174 may be used to move extension 88E in the +Z and −Z directions (e.g., by adjusting an adjustment mechanism, such as a lever).

Global actuator 168 may be coupled to the multiple indirect actuators 90 through adjustment mechanism 170. Adjustment mechanism 170 may be a solid component and may be formed from metal, plastic, or another suitable material. Although adjustment mechanism 170 is shown as being a linear member in the illustrative example of FIG. 16, adjustment mechanism 170 may be curved (e.g., to match the shape of tunable lens 72-2 of FIG. 6), if desired.

In operation, global actuator 168, which may include one or more shape memory alloy (SMA) wires, motors, magnets, hydraulic actuators, and/or any other suitable actuators, may move adjustment mechanism 170 in directions 172 (e.g., in the +Y and −Y directions). Because preload force components 174 of indirect actuators 90 are coupled to adjustment mechanism 170, the movement of adjustment mechanism 170 may adjust an amount of force stored in preload force components 174. Therefore, global actuator 168 may adjust the amount of force provided when preload force components 174 are used to adjust the positions of extensions 88E.

In general, a single global actuator 168 and adjustment mechanism 170 may be coupled to all of the indirect actuators 90 in a tunable lens, or multiple global actuators 168 may be used. For example, each global actuator 168 may be coupled to two or more, three or more, or four or more indirect actuators 90, as examples.

As discussed, any of the actuating components (and actuators) of FIGS. 7-16 may be formed from an SMA wire. However, if the effective stiffness of the SMA wire becomes zero (e.g., due to the counterbalanced preloaded force and the load of extension 88E), the SMA wire may be uncontrollable. To ensure that the SMA wire can remain controlled when a preloaded force is used, time damping and/or inertia may be used to add force the SMA wire and prevent it from becoming uncontrolled. The time damping and/or inertia may introduce a temporal variation in the stress seen by the SMA wire, allowing the steady state force reduction per unit contraction of the SMA wire to extend beyond the typical controllable limit by balancing the thermal time response of the SMA wire to a power change against the stress required to drive the acceleration and velocity of the wire. As such, the actuator can be made to achieve a set position stability target by tuning the controller resolution in time and power plus the system inertia and damping.

However, modulating inertia and/or damping to ensure that the SMA wire remains controllable is merely illustrative. In other embodiments, an antagonistic wire (e.g., another SMA wire or a selectively powered wire or motor-driven wire) may be used to add force. For example, the antagonistic wire may be powered/controlled only during part of the activation of the SMA wire to reduce the stress strain gradient of the SMA wire. Alternatively or additionally, the actuator pivot may be designed to have variable friction throughout the stroke, such as through a variable surface finish, variable shape, and/or variable contact pressure. Alternatively or additionally, the actuator may pass into and out of a damping compound, such as gel, during regions of instability. In this way, the stability of an SMA wire may be maintained.

The foregoing is merely illustrative, and various modifications can be made to the described embodiments. The foregoing embodiments may be implemented individually or in any combination.

What is claimed is:

1. A tunable lens, comprising:
a lens shaping element; and
an indirect actuator coupled to the lens shaping element, wherein the indirect actuator comprises:
a preloaded force component,
an adjustment mechanism coupled to the preloaded force component, and
an actuating component coupled to the adjustment mechanism, wherein the actuating component is configured to adjust the adjustment mechanism to adjust the lens shaping element using a preloaded force from the preloaded force component.

2. The tunable lens of claim 1, wherein the preloaded force component comprises a preloaded spring.

3. The tunable lens of claim 1, wherein the preloaded force component comprises a fluid-filled component.

4. The tunable lens of claim 1, wherein the preloaded force component comprises a magnetic component.

5. The tunable lens of claim 1, wherein the preloaded force component comprises a compression spring and a tension spring, the adjustment mechanism is between and coupled to the compression spring and the tension spring, and the actuating component is configured to move the adjustment mechanism to adjust the lens shaping element using the preloaded force.

6. The tunable lens of claim 5, wherein the actuating component comprises first and second shape memory alloy wires that are configured to move the adjustment mechanism to adjust the lens shaping element.

7. The tunable lens of claim 1, wherein the preloaded force component comprises a preloaded spring, the adjustment mechanism comprises a lever that rotates about a pivot, and the adjustment mechanism is configured to move the pivot to adjust the lens shaping element using the preloaded force from the preloaded spring.

8. The tunable lens of claim 1, wherein the preloaded force component comprises a preloaded spring and a cantilever beam, and the adjustment mechanism is configured to move the cantilever beam to adjust the lens shaping element using the preloaded force from the preloaded spring.

9. The tunable lens of claim 1, wherein the preloaded force component comprises a preloaded spring, the adjustment mechanism comprises a lever configured to rotate about a pivot, the preloaded spring is coupled to an end of the lever, the actuating component comprises a shape memory alloy wire coupled to the end of the lever, and the lens shaping element is coupled to the end of the lever.

10. The tunable lens of claim 1, wherein the indirect actuator is a first indirect actuator of a plurality of indirect actuators, and each of the plurality of indirect actuators is coupled to a global actuator that is configured to adjust the preloaded force of the preloaded force component.

11. The tunable lens of claim 1, wherein the actuating component comprises a shape memory alloy wire.

12. The tunable lens of claim 1, wherein the indirect actuator further comprises a socket, and the adjustment mechanism forms a ball and socket with the socket.

13. The tunable lens of claim 1, wherein the indirect actuator further comprises a tension pivot and sliding joint to which the adjustment mechanism is coupled.

14. The tunable lens of claim 1, wherein the adjustment mechanism comprises a flexure.

15. The tunable lens of claim 1, wherein the indirect actuator further comprises a piezoelectric brake.

16. An indirect actuator configured to adjust a lens shaping element of a tunable lens, the indirect actuator comprising:
a preloaded force component,
an adjustment mechanism coupled to the preloaded force component, and
an actuating component coupled to the adjustment mechanism, wherein the actuating component is configured to adjust the adjustment mechanism to adjust the lens shaping element using a preloaded force from the preloaded force component.

17. The indirect actuator of claim 16, wherein the preloaded force component comprises a compression spring and a tension spring, the adjustment mechanism is between and coupled to the compression spring and the tension spring, and the actuating component is configured to move the adjustment mechanism to adjust the lens shaping element using the preloaded force.

18. The indirect actuator of claim 17, wherein the actuating component comprises first and second shape memory alloy wires that are configured to move the adjustment mechanism to adjust the lens shaping element.

19. The indirect actuator of claim 16, wherein the preloaded force component comprises a preloaded spring, the adjustment mechanism comprises a lever that rotates about a pivot, and the adjustment mechanism is configured to move the pivot to adjust the lens shaping element using the preloaded force from the preloaded spring.

20. The indirect actuator of claim 16, wherein the preloaded force component comprises a preloaded spring, the adjustment mechanism comprises a lever configured to rotate about a pivot, the preloaded spring is coupled to an end of the lever, the actuator comprises a shape memory alloy wire coupled to the end of the lever, and the lens shaping element is coupled to the end of the lever.

21. A tunable lens, comprising:
a lens shaping element; and
an indirect actuator coupled to the lens shaping element, wherein the indirect actuator comprises:
at least one preloaded spring,
an adjustment mechanism coupled to the at least one preloaded spring, and
an actuating component coupled to the adjustment mechanism, wherein the actuating component is configured to adjust the adjustment mechanism to adjust the lens shaping element using a force from the at least one preloaded spring.

22. The tunable lens of claim 21, wherein the at least one preloaded spring comprises a compression spring and a tension spring.

23. The tunable lens of claim 21, wherein the adjustment mechanism comprises a lever that is configured to rotate about a pivot, and the actuating component is configured to move the lever to adjust the lens shaping element using the force from the at least one preloaded spring.

24. The tunable lens of claim 21, wherein the indirect actuator is a first indirect actuator of a plurality of indirect actuators, and each of the plurality of indirect actuators is coupled to a global actuator that is configured to adjust the force of the preloaded spring.
